(19) United States
(12) Patent Application Publication
(10) Pub. No.: US 2004/0205740 A1
(43) Pub. Date: Oct. 14, 2004

(54) Method for collection of memory reference information and memory disambiguation

(76) Inventors: Daniel M. Lavery, Santa Clara, CA (US); David C. Sehr, Sunnyvale, CA (US); Rakesh Ghiya, Santa Clara, CA (US)

Correspondence Address: R. Alan Burnett, BLAKELY, SOKOLOFF, TAYLOR & ZARMAN LLP, Seventh Floor, 12400 Wilshire Boulevard, Los Angeles, CA, 90025-1026, US

(21) Appl. No.: 09/823,182

(22) Filed: Mar. 29, 2001

(51) Int. Cl. G06F 9/45

(52) U.S. Cl. 717/151

(57) ABSTRACT

A memory disambiguation method and system that provides accurate memory disambiguation and is efficient in compile time and memory usage. The method preserves high-level and intermediate-level semantics and other information necessary for disambiguation in a new structure called a disam token. The disam token and a symbolic memory reference representation associated with it are also the means by which the various memory disambiguation modules and their clients communicate, forming the basis of a complete memory disambiguation system. The method includes an algorithm for creating and maintaining the disam tokens and disambiguation information and an algorithm for applying various disambiguation rules that utilize the information during program and/or module compilation.

### BACKGROUND OF THE INVENTION

1. Field of the Invention

The present invention concerns compilers in general, and more specifically concerns a method for collecting memory information and using such information to provide memory disambiguation.

2. Background Information

Memory disambiguation is the process of determining the relationship between the memory locations accessed (or possibly accessed) by a pair of loads, stores, and/or function calls. Compilers perform memory disambiguation to ensure correctness and enhance the effectiveness of optimizations and scheduling. For example, the compiler must determine that a load and store never access the same memory location in order to reorder them during code scheduling. In addition, the compiler must determine that two loads always access the same memory location in order to remove the later redundant load. If the compiler does not have enough information to disambiguate a pair of memory references, it must be conservative, potentially inhibiting an optimization. For processors that exploit high levels of instruction-level parallelism (ILP), conservative memory disambiguation decisions are a significant performance bottleneck. Current memory disambiguation methods are either too conservative or are inefficient in compile time or memory usage.

Modern processors face the ever-increasing gap between processor core speeds and memory speeds. Because of this, the effective cost of a load operation may range from single-digit cycles for cache accesses up to hundreds of cycles for main memory accesses. The best solution to this problem, as always, is to eliminate as many memory references as possible. Large register files make register promotion of very large numbers of locations practical. To hide the latency of those that remain, the compiler would still like to have maximum freedom to schedule them. Some modern processors, such as the Intel Itanium™ processor, incorporate data speculation to allow scheduling freedom across some data dependencies that would otherwise sequentialize the schedule. However, the data speculation resources are finite and their use subject to certain constraints. It is therefore still of the foremost importance to prove memory references independent whenever possible. Both of these tasks, register variable promotion and scheduling, rely intimately on the best possible memory disambiguation technology.

Many of a compiler's optimizations that rely on memory disambiguation occur in the compiler backend, and interact with a disambiguator in complicated ways. For instance, to generate efficient code for a machine with a single register-indirect addressing mode requires that addresses be lowered to base and offset early in the compilation. Typically, after the program representation is lowered and optimizations are performed, much of the source-level information is lost and the code is transformed in ways that make it more difficult for the compiler to perform memory disambiguation. For example, after optimization an array reference a[i] in a source-level loop becomes a register indirect reference off an induction variable that is initialized outside the loop. It then takes a good deal of searching to find out which array is accessed, let alone which element. Another example is that lowering may make disambiguation much more difficult by obscuring such simple facts as two scalar variables that are not contained in the same structure can never conflict. Therefore the disambiguator needs to retain a certain amount of “high-level” information about storage locations.

Relying solely on high-level information, though, may result in missed opportunities as well. Notably, if the program contained pointer arithmetic such as the following fragment, lowered addressing and constant propagation are needed to prove that s.b can be registerized across the store whenever i is zero. Because of this interaction between disambiguation and optimizations, an effective disambiguator will need to incorporate information from a variety of semantic levels of the intermediate language (IL).

struct {int a, b;}s;

int *p=&s.a;

s.b=0;

*(p+i)=1;

. . . =s.b;

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a block diagram illustrating the disambiguation token of the present invention;

FIGS. 2A and 2B illustrate various types of memory locations (LOCS) corresponding to memory references and function calls for an exemplary function;

FIG. 2C illustrates a local and global LOC set corresponding to memory references in an exemplary function;

FIG. 3 is a block diagram illustrating various components of a disambiguation token corresponding to a direct memory reference;

FIG. 4 is a block diagram illustrating various components of a disambiguation token corresponding to an indirect memory reference;

FIG. 5 is a block diagram of an exemplary compiler that implements the present invention;

FIG. 6 is a block diagram illustrating the various modules used during memory disambiguation and the interfaces between them.

FIGS. 7A-D collectively comprise a flowchart illustrating the logic used by the present invention during a compilation process that implements the disambiguation method of the present invention;

FIGS. 8A-C collectively comprise a flowchart illustrating the logic used by the disambiguator module of the present invention during the compilation process; and

FIG. 9 is a block diagram of an exemplary computer system on which the present invention can be implemented.

### DETAILED DESCRIPTION OF THE ILLUSTRATED EMBODIMENTS

A method and system for memory disambiguation is described in detail herein. In the following description, numerous specific details are provided to provide a thorough understanding of embodiments of the invention. One skilled in the relevant art will recognize, however, that the invention can be practiced without one or more of the specific details, or with other methods, components, etc. In other instances, well-known structures or operations are not shown or described in detail to avoid obscuring aspects of various embodiments of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

One aspect of the present invention comprises a novel memory disambiguation method that provides accurate memory disambiguation that is efficient in compile time and memory usage. The method preserves high-level semantics and other information necessary for disambiguation in a new structure called a disam token. The disam token and a symbolic memory reference representation associated with it are also the means by which the various memory disambiguation modules and their clients communicate, forming the basis of a complete memory disambiguation system. An algorithm for creating and maintaining the disam tokens and disambiguation information and an algorithm for applying various disambiguation rules that utilize the information are discussed in detail below.

Disam tokens are created for each memory reference after the interprocedural analysis and optimization (including inlining) is done, but before the optimization of each individual function. Alternatively, disam tokens could be created before interprocedural analysis and optimization. A unique disam token is associated with every memory reference in the function that the compiler is currently processing. The disam token provides access to all the information (either directly or through other links) necessary to perform memory disambiguation. Examples of disam tokens include, but are not limited to, a data structure embedded in the memory reference operators of the intermediate language (IL) or a separate data structure linked to the memory reference operator via a pointer or hash table lookup.

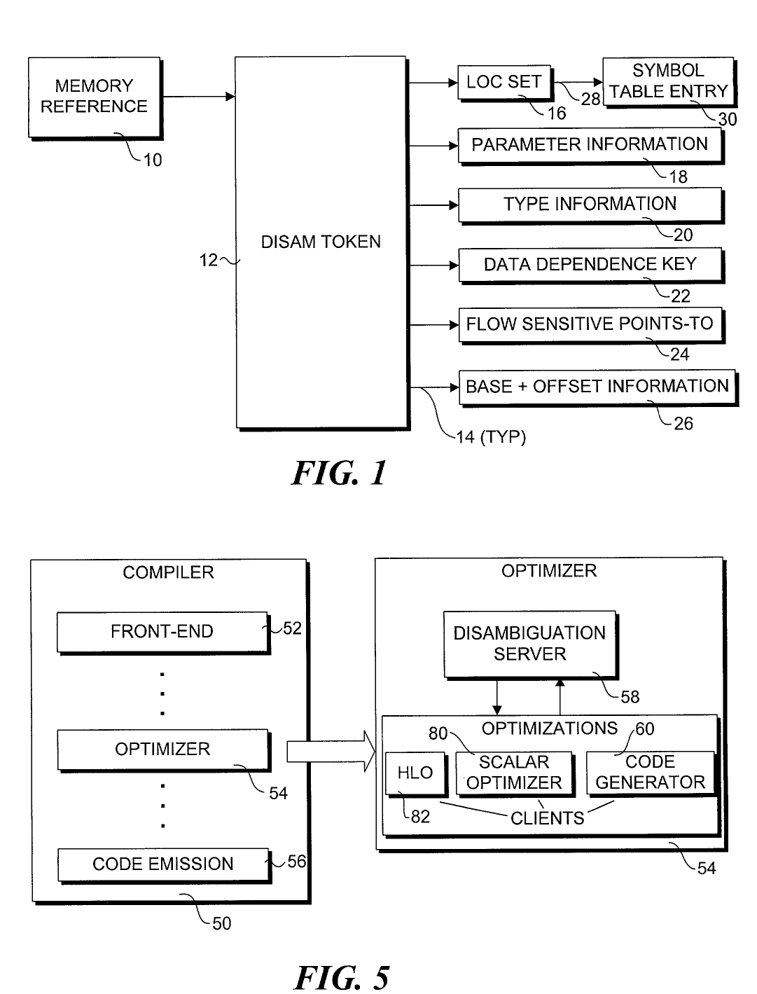

The relationship between a memory reference, its disam token, a symbolic memory reference representation, and other information needed for memory disambiguation are illustrated in FIG. 1. Each memory reference 10 is associated with a disam token 12. Each disam token 12 includes a plurality of links 14 (e.g., pointers) to where various information pertaining to the disam token and its use are stored, including a LOC set 16, parameter information 18, type information 20, a data dependence key 22, a flow-sensitive points-to 24, and base+offset information 26. As described in further detail below, LOC set 16 contains a pointer 28 to a symbol table entry 30

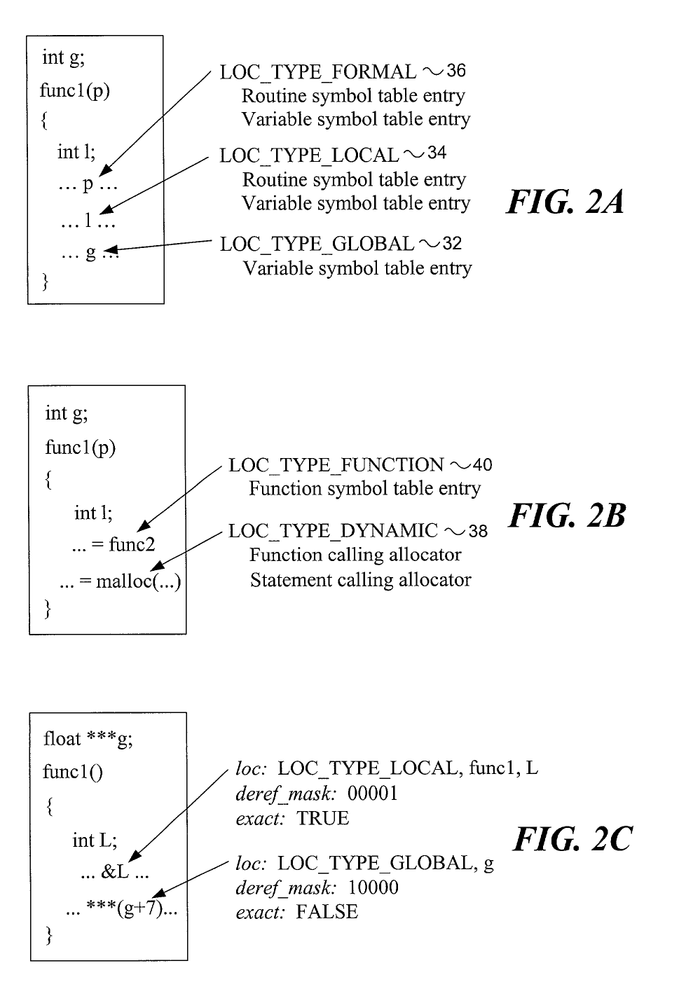

Memory references are represented symbolically using a data structure called a LOC set. There are several types of LOCs corresponding to the various types of storage locations, as illustrated in FIGS. 2A-B. For example there are LOCs representing global variables 32, local variables 34, formal and actual function parameters 36, registers, dynamically allocated heap objects 38, and even the text of a function 40.

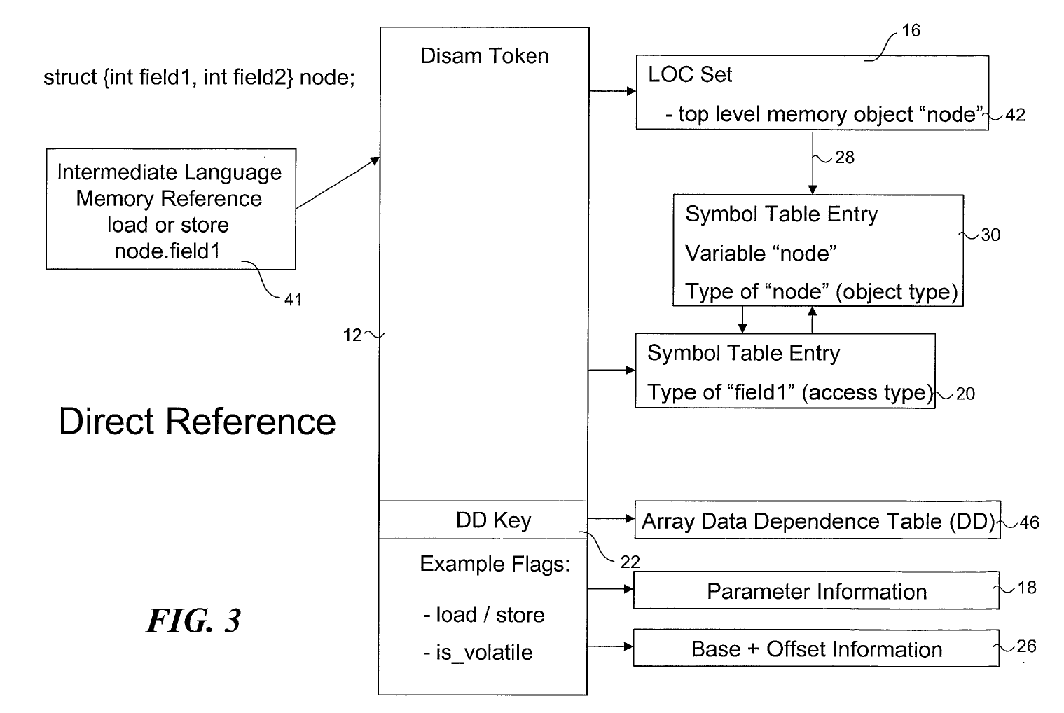

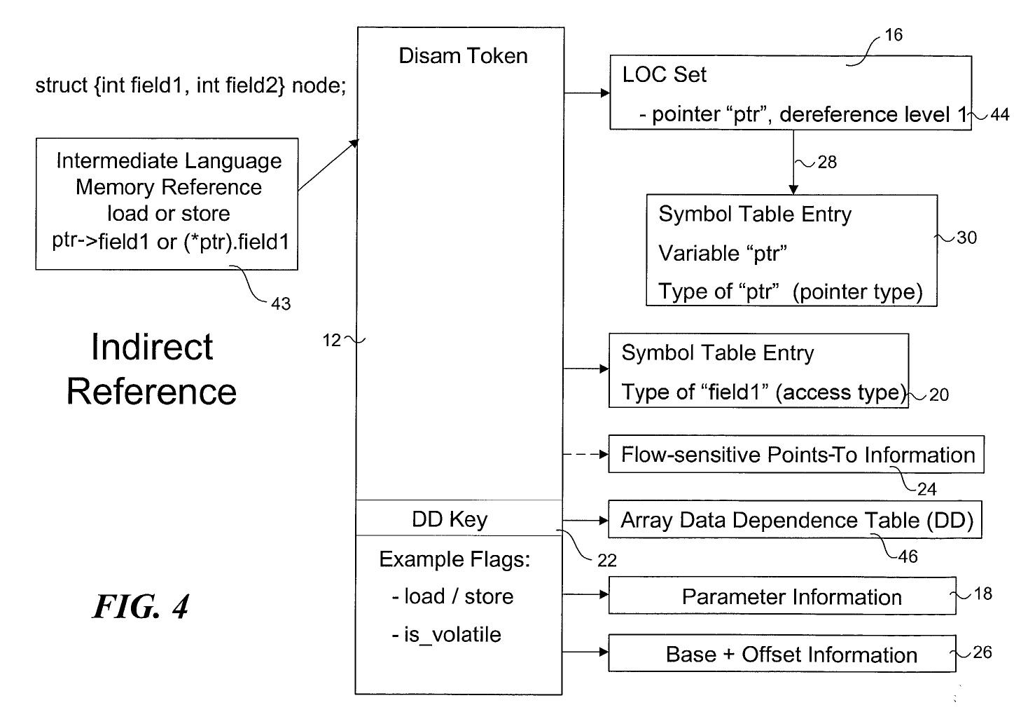

The contents of the LOC set vary depending on the type of memory reference. As shown in FIG. 3, for direct memory references 41, LOC set 16 contains a single LOC 42 representing the memory object (local or global variable) that is accessed. For indirect memory reference 43, LOC set 16 contains a single LOC 44 representing a pointer and the dereference level, as depicted in FIG. 4. The LOC provides access to the symbol table information associated with the memory object accessed (direct references) or the pointer (indirect references). FIG. 2C shows LOC sets for memory references with various levels of dereference. The dereference level is represented by a dereference mask. Bit position 0 in the mask represents the address of operator (&), position 1 represents a direct memory reference, position 2 represents an indirect reference with dereference level 1 (1 star), position 2 dereference level 2 (2 stars) and so on. FIG. 2C shows the dereference masks in binary.

The disam token also contains a link to the type information 20 for the memory reference. For array references, the disam token contains a data dependence key 22 that is used to access a table of array data dependence information 46. For Indirect references, the disam token provides an interface to flow-sensitive points-to information 24. This information must be stored for each memory reference rather than for each pointer. Finally, the disam token also contains information about parameters and copies of parameters, as represented by parameter information 18, and base and offset information for low-level disambiguation, as represented by base+offset information 26.

Disam tokens are created early in the compiler while the memory references are still in a form that is similar to the source code and before variables are promoted to registers so as not to lose the symbol table information for pointers that get registerized. All loads and stores eventually become indirect off registers and it is hard to determine at that point whether the memory reference was originally direct or indirect.

Forward substitution can have an effect similar to copy and constant propagation. For example, the following sequence of code:

t=&a

foo (t[i]);

would become:

foo(a[i]);

after forward substitution. t[i] is an indirect reference while a[i] is a direct reference. For reasons of both performance and correctness, the disam token information must be updated to reflect this transformation.

Disam tokens must be maintained whenever memory references are created, copied, or translated to a different form as shown in the process above. Whenever a memory reference is copied by an optimization, the associated disam token is automatically copied. At selected points during the compilation, the disam tokens are verified to make sure that there is still a token for each memory reference and that the contents of the token look reasonable. The purpose of this is to catch any errors in the maintenance of the disam tokens.

With reference to FIG. 5, an exemplary compiler architecture 50 in which the present invention may be implemented includes a front-end 52, an optimizer 54, and a code generator 56, as well as other conventional compiler blocks that are not shown. In addition to performing conventional compilation optimizations, optimizer 54 performs the memory disambiguation method of the invention using a disambuguation server 58 that provides disambuguation services to various optimization clients, including high level optimizer (HLO) clients 82, scalar optimizer clients 80, and code generator clients 60.

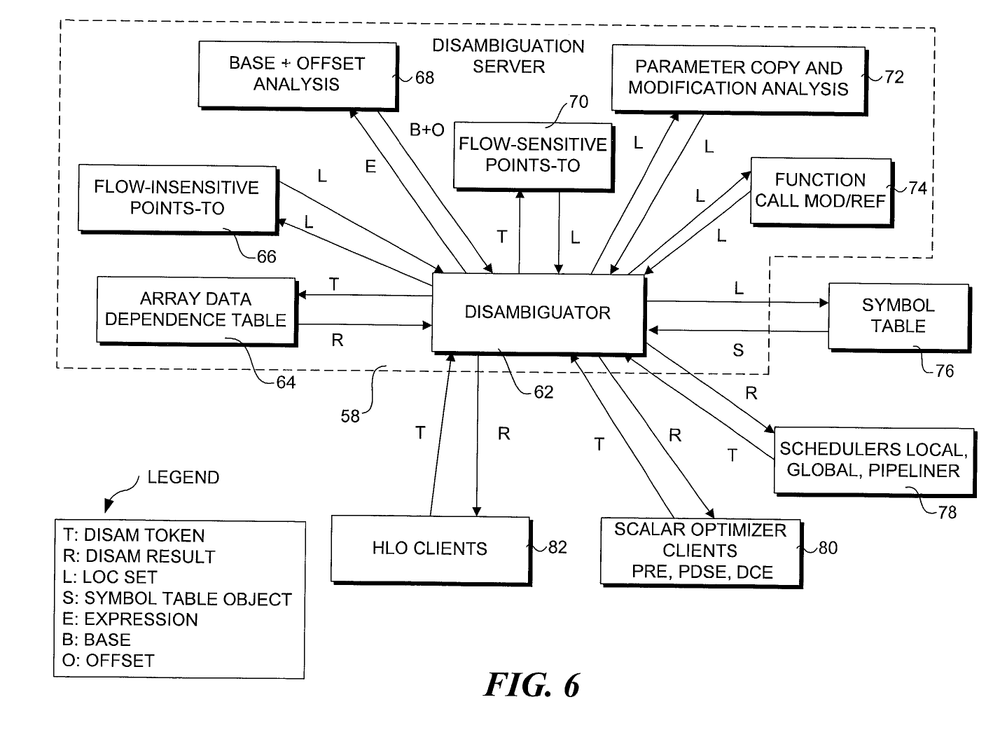

FIG. 6 shows a block diagram of the various modules involved in memory disambiguation and the interfaces between them. A disambiguator module 62 receives queries from a client, queries the other modules if necessary, interprets all the information, and returns a disambiguation result. Note that both the sources of disambiguation information and the clients operate at various levels of abstraction in the compiler. For example points-to and MOD/REF analysis occur early during interprocedural analysis, array data dependence analysis occurs in the middle of the compilation after loops have been unrolled, and base and offset analysis occurs late after the memory references have been translated to their lowest level form. The clients range from the high level optimizer to the code schedulers. What allows the disambiguator to communicate with them all is the disam token and LOC framework. With the exception of the base and offset analysis, the disambiguator views the memory references in the same way throughout the compilation. Simply by looking at the disam token, the low level loads and stores that the scheduler wants to reorder are translated to a form that the high-level points-to analysis and symbol table understand. Clients pass the two memory references to the disambiguator using disam tokens which are independent of the different ILs used by the optimizer and code generator.

As shown in FIG. 6, disambiguator 62 interacts with a plurality of modules that are internal to disambiguation server 58, including an array data dependence table 64, a flow-insensitive points-to module 66, a base+offset analysis module 68, a flow-sensitive points-to module 70, a parameter copy and modification analysis module 72, and a function call mod/ref module 74. Disambiguator 58 also interacts with several external (to disambiguation server 58) modules, including a symbol table 76, various schedulers 78, various optimizer clients 80, and high-level optimizer (HLO) clients 82.

If both memory references are direct (note that direct vs. indirect is easily determined from the LOC set representation of the memory reference), their LOC sets are compared to determine whether or not the same memory object is accessed. LOCs are created in such a way that if the LOCs are different, then different memory objects are accessed. If the same object is accessed, the disambiguator then attempts to determine if overlapping portions of the object are accessed. From the symbol table information, the disambiguator can find out the type of the high-level object accessed, such as a scalar, array, or record (structure). For example, the array data dependence information is used to determine if the same array element is accessed. For example, for array references, the disam token contains a key that is used to access a table of data dependence information. For two references to the same array object, a table lookup is done using the two keys. The result of the lookup is an indication of whether or not there is a dependence between the two array references and the characteristics of that dependence. In addition to array references, the data dependence key and table can be used to encode information about dependences between any two memory references. For example, in loops containing directives to ignore dependences, the data dependence keys and table are used to encode information for any pairs of memory references that the disambiguator is not able to disambiguate without using the directive. Structure type information from the symbol table is used to determine if overlapping fields of a structure are accessed. This information is generated by the front-end and is attached to the memory references in the IL. This information is stored in the disam token when the memory references are translated to the code generator's IL. The type information contains the type and offset information for the field within the structure.

Compiler generated references can often be easily disambiguated from all other memory references. For example, references to read only storage areas can be disambiguated from all stores. The Itanium™ software conventions require several forms of read only objects, notably for function pointers and for global variable accessing. The disambiguator can trivially prove these references independent.

If at least one of the memory references is indirect, the disambiguator first attempts to prove independence without knowing where the indirect references point to. The LOC for the pointer is used to look up the symbol table information for that pointer. The disambiguator also maintains a table of information about parameters and copies of parameters. This information is stored in a hashtable indexed by the LOC. For example, an indirect reference off an unmodified parameter or a copy of that parameter could not possibly access a stack allocated local variable from the function in which the two references appear. When the compiler is run with interprocedural optimization, it has the ability to automatically detect that it is seeing the whole program. That is it can detect whether or not there are calls to functions that it has not seen and does not know the behavior of. When the compiler can see the whole program, the disambiguator knows that an indirect reference cannot possibly access a global variable that has not had its address taken. Address taken information is available through the symbol table.

Next, the disambiguator turns to a method that utilizes the lowered addressing. It analyzes the address expression of each memory reference and tries determine a base and offset. If successful it caches the information in the disam token and compares the base and offset for the two memory references. If they have the same base, the disambiguator can use the offsets and sizes of the memory references to determine whether or not they overlap.

If simple rules such as those above do not allow the disambiguator to prove independence of the memory references, the results of points-to analysis are consulted. For each memory reference, the disambiguator passes the LOC set representing the memory reference to the points-to interface, which returns a LOC set representing the set of locations that could be accessed by that memory reference. The disambiguator then compares the LOC sets to determine if there is any overlap. In the case of flow-sensitive points-to, the disam token contains the points-to LOC set.

Flow-insensitive points-to analysis is conducted based on summary information collected before procedure inlining. However, as the inliner makes a copy of the callee function to insert in the caller, it converts the local variables in the callee into new local variables in the caller. Disam tokens are created after inlining and therefore the LOCs are created for the new local variables in the caller rather the variables in the original copy of the callee. Because the new local variable in the caller (and the corresponding LOC) did not exist at the time that points-to analysis was done and the key to obtain the points-to set of a variable is the LOC representing the pointer, we are not able to obtain the points-to sets of the new local variables in the caller. To solve this problem, we keep a pointer in each variable data structure, to the “original” LOC corresponding to it. While converting a local variable of the callee into a local variable of the caller during inlining, we initialize the original_LOC pointer of the new variable to the original_LOC pointer of the original variable. This enables the disabiguator to obtain the original LOC representing the local variable in the original copy of the caller and query the points-to interface. When not querying points to information, the disambiguator uses the LOC representing the new local variable. Thus when there are two copies of the same callee inlined at two different call sites within the same caller, there are two different sets of new local variables and the disambiguator can distinguish between them.

Finally, the disambiguator can perform type-based disambiguation based on the languages type aliasability rules. For example, under the ANSI C type aliasability rules, a reference to an object of type float cannot overlap with a reference to an object of type integer.

As discussed above, disam tokens are also associated with all function calls. Clients can query the disambiguator with the tokens for a memory reference and a function call. The disambiguator passes a LOC set representing the function call (recall that LOCs can represent functions) to the MOD/REF module and receives a LOC set representing the set of memory locations that could be modified (written) or referenced (read) as a result of the function call. In the MOD/REF module, the compiler performs some kind of mod/ref analysis, which comprises determining the set of memory location modified (written) or referenced (read) by each function. This could be as simple as knowing that certain library functions do not modify or reference any user program variables, or as complex as a full interprodecural analysis. The set of locations modified or referenced is represented as a mod or ref LOC set respectively. These are stored for in the MOD/REF module for later use by the disambiguator. For indirect calls, there is a LOC set representing the dereferenced pointer. The points-to interface is then queried to determine the set of functions that could be called. The MOD or REF sets for these functions are unioned across the different functions in the set. The disambiguator then intersects the LOC set for the memory reference with the MOD or REF set for the function call to determine if the function call reads or writes any of the same memory locations accessed by the memory reference.

Another capability of this disambiguation method is the ability to compute the address relationship between a pair of memory references. This information is needed for the compiler to optimize around memory system limitations such as cache bank or store buffer conflicts. The information can be used by the schedulers to compute artificial dependences for scheduling around memory system limitations and to do post-increment optimization. Also, it can be used by the high-level optimizer to coalesce loads and stores (combine a sequence of small loads or stores into fewer larger loads or stores). Computation of address relations is similar to determination of overlap except that instead of returning dependent or independent, the disambigutor uses the information in the disambiguator tokens to compute the difference in starting addresses of two memory references and the alignment of the two memory references.

Another capability of this disambiguation method is to determine the exact nature of the overlap between memory references. For example, using the information in the disambiguation token, it can determine if one memory reference overlaps exactly with another (same starting address and same size) or if one memory reference is a subset of the other. This information can be used by the optimizer to generate the code needed to perform store forwarding in the case of a store followed by a load of a subset of the bytes stored.

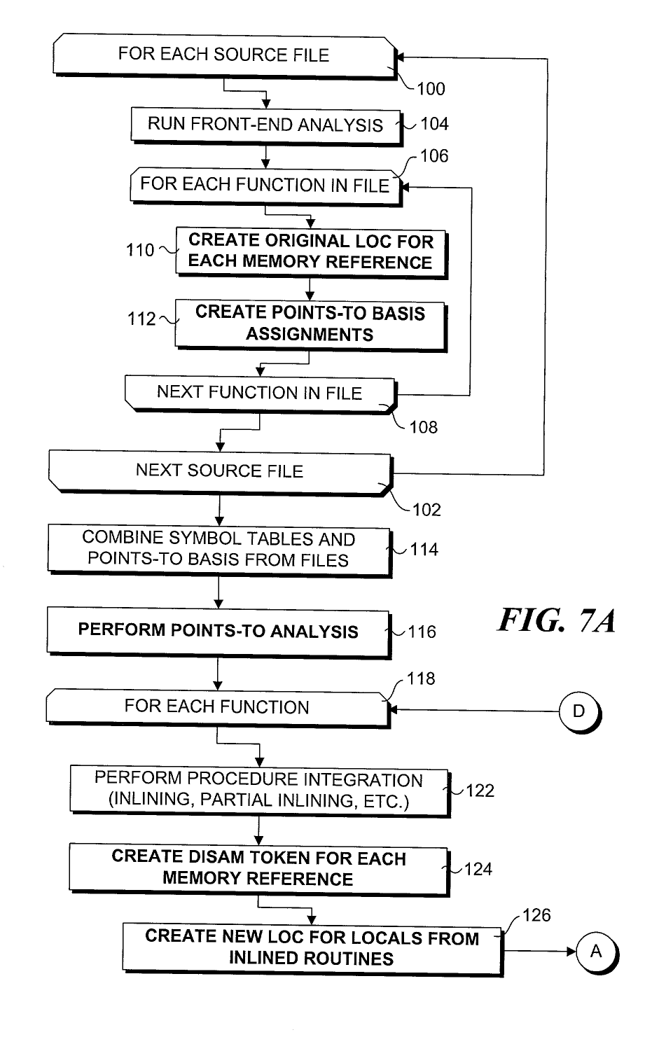

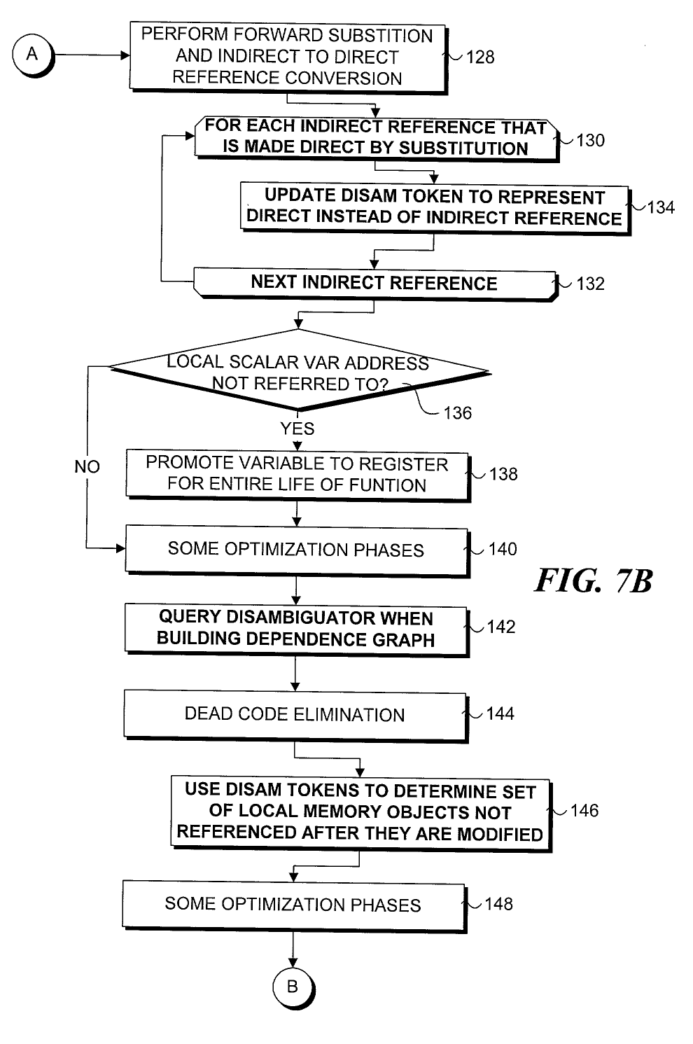

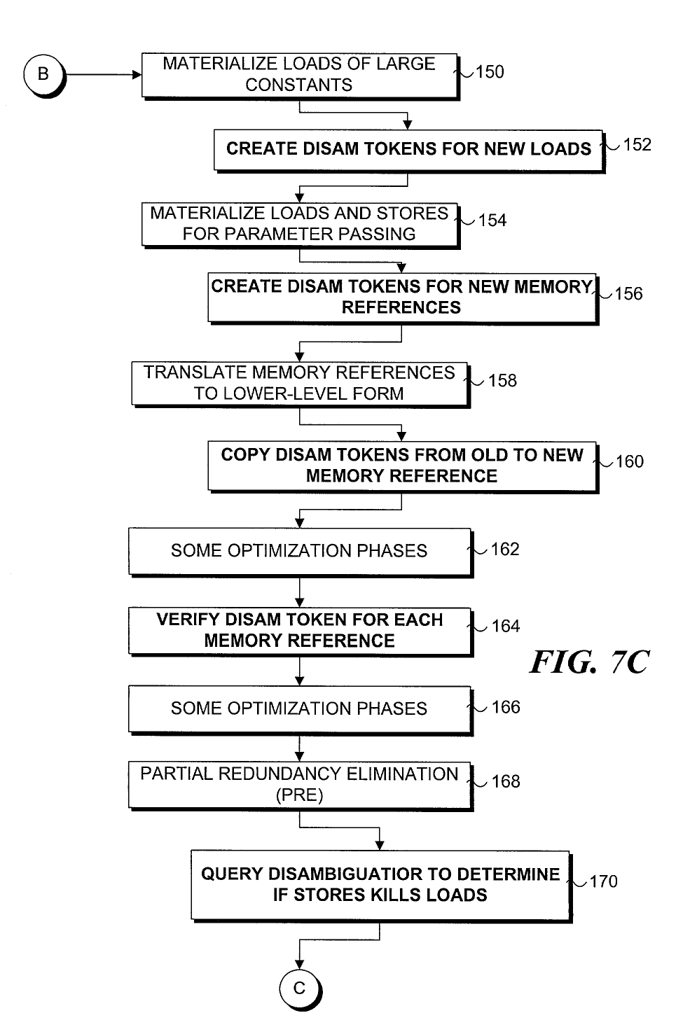

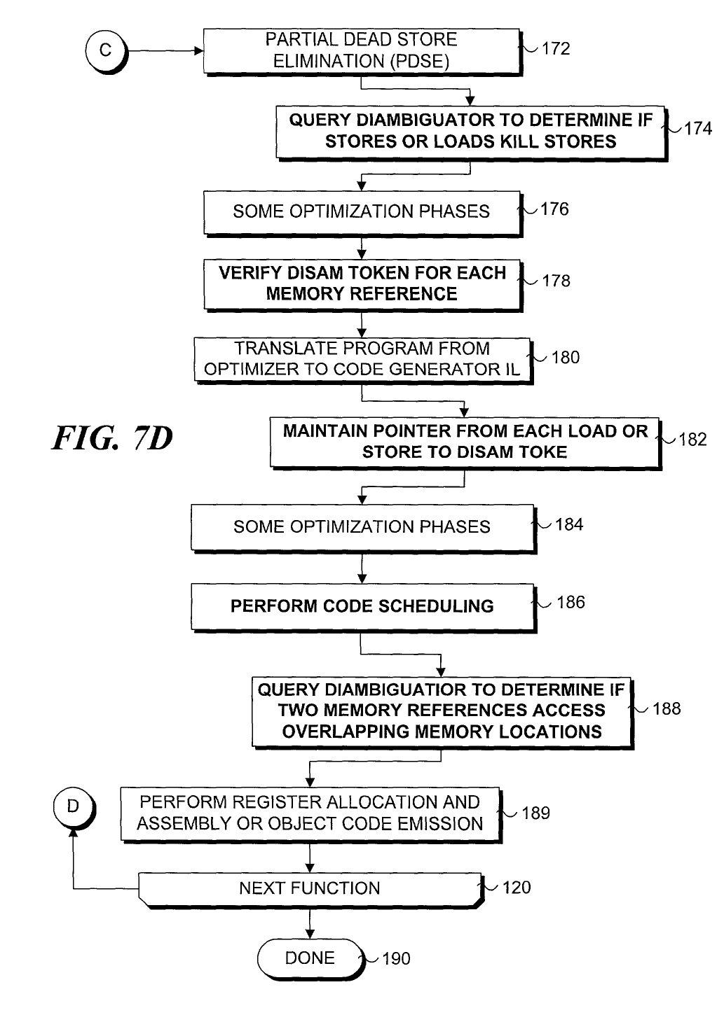

In general, a compiler that implements the present invention will perform a conventional compilation process augmented with various functions corresponding to the memory disambiguation method of the invention. With reference to the flowchart illustrated in FIGS. 7A-D, the logic implemented by such a compiler for collection, maintenance, and use of disambiguation information during a compilation process is illustrated, wherein conventional compilation functions are depicted as boxes with non-bolded text, while functions pertaining to the memory disambiguation functions provided by the invention are depicted in boxes with bolded text.

As indicated by start and end loop blocks 100 and 102, the compilation process begins by performing some initialization functions on each source file that is part of the compilation, including a front-end analysis, as provided by a block 104. The front-end analysis includes lexical and syntactic analysis, creation of the symbol table, semantic analysis, and other common front-end functions that are well-known in the art. As indicated by start and loop block 106 and 108, for each function in the current file an original LOC is created for the left-hand side and right-hand side of each assignment in a block 110, and points-to basis assignments are created in a block 112.

After the initialization functions have been applied to the source files, the symbol tables and point-to basis from the files are combined in a block 114. A points-to analysis is then performed in a block 116. This comprises the processing of the points-to basis assignments for each function or across all functions and building a points-to graph that describes the set of memory objects accessible through each pointer. As identified by a start loop block 118 and an end loop block 120 in FIG. 7D, a set of functions described in the following paragraphs are then applied to each function.

In a block 122, conventional procedure integration is performed. This will typically comprise inlining and partial inlining of procedures and functions. Next, a disam token for each memory reference is created in a block 124, while new LOCs for local memory references from the inlined routines are created in a block 126.

With reference to FIG. 7B, the flowchart continues in a block 128 in which a forward substitution and indirect to direct reference conversion is performed. This is particularly important for Fortran and C++ by-reference parameters that can become direct references after inlining. As provided by start and end loop blocks 130 and 132, for each indirect reference that is made into a direct reference by substitution, a corresponding disam token is updated to represent a direct reference instead of the previous indirect reference, as provided by a block 134. Next, in a decision block 136 a determination is made to whether the function has any local scalar variables whose address is not referred to. If the answer is yes, the logic proceeds to a block 138 in which such local scalar variables are promoted to registers for the entire life of the function.

A first set of conventional optimization phases are performed in a block 140. The optimization phases shown in the Figures are intended to be examples. As will be recognized by those skilled in the art, the number and type of optimizations phases may vary, depending on the particular implementation. Next, in a block 142, the high-level optimizer 82 queries disambiguator 62 when building dependence graphs. Dead code elimination is then performed in a block 144, which includes using the disam tokens to determine the set of local memory objects that are not referenced after they have been modified, as provided by a block 146. A second set of conventional optimization phases are then performed in a block 148, and the flowchart advances to a block 150 in FIG. 7C.

In block 150, loads of large constants are materialized. This includes creating disam tokens for new loads, as provided by a block 152. Loads and stores for parameter passing are then materialized in a block 154, which includes creating disam tokens for new memory references in a block 156. Memory references are then translated to a lower-level form in a block 158, which includes copying disam tokens from old to new memory references in a block 160. A third set of optimization phases are then performed in a block 162.

The logic next proceeds to a block 164 in which the disam token for each memory reference is verified. A fourth set of optimization phases are then performed in a block 166. Partial redundancy elimination (PRE) is next performed in a block 168, which includes querying disambiguator 62 to determine if stores kill (i.e., overlap with) available loads.

With reference to FIG. 7D, the logic next proceeds to a block 172 in which partial dead store elimination is performed. As provided by a block 174, this includes querying disambiguator 62 if stores or loads kill any later stores. A fifth set of optimization phases are then performed in a block 176.

Next, the disam token for each memory reference is verified in a block 178. The program is then translated from the optimizer to code generator IL in a block 180, which includes maintaining a pointer from each load or store to a corresponding disam token, as provided by a block 182. A sixth set of optimization phases is then performed in a block 184.

The compiler then performs code scheduling, which includes querying disambiguator 62 to determine if two memory references access overlapping memory locations, as provided by blocks 186 and 188. Processing of the current function is completed by performing register allocation and assembly or object code emission in a block 189. The logic then loops back to block 118 to begin processing the next function. Processing of each function in a similar manner to that described above is continued until all of the functions have been processed, thereby completing the compilation process, as indicated by a block 190.

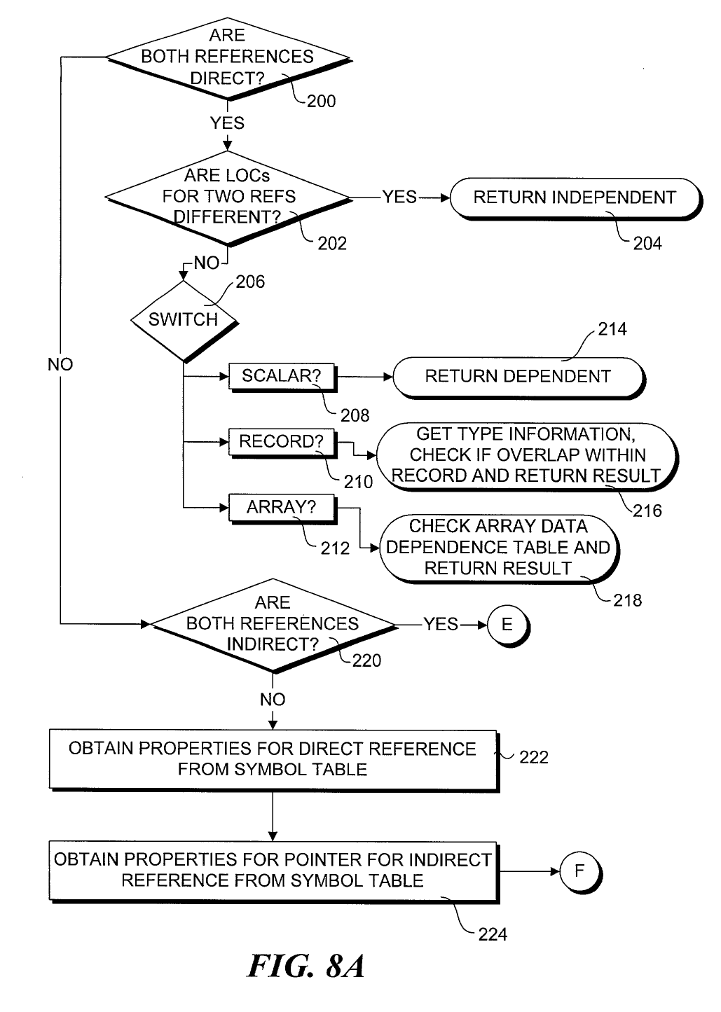

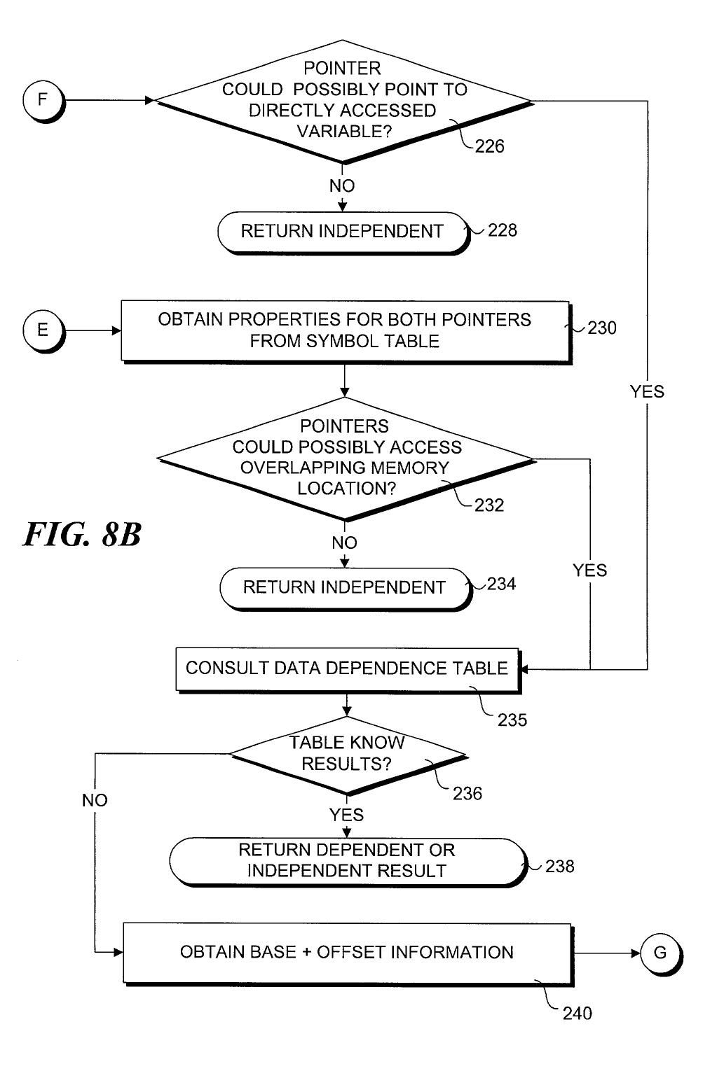

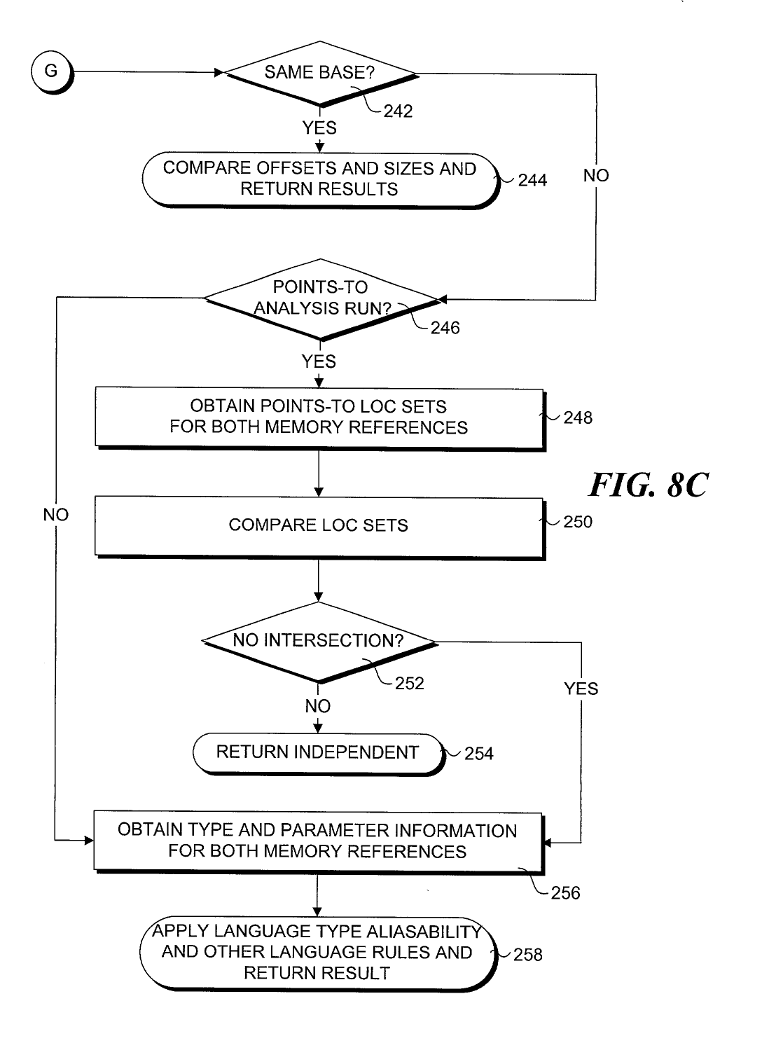

Details of the memory disambiguation process are shown in the flowchart of FIGS. 8A-C. With respect to the flowchart and the following discussion, a disambiguation process as applied to two memory references is presented. With reference to a decision block 200, a determination is made to whether both memory references are direct. This can be easily determined from the LOC set representation of the memory reference. If both memory references are direct, the logic proceeds to a decision block 202, in which the LOC sets are compared to determine whether or not the same memory object is accessed. LOCs are created in such a way that if the LOCs are different, then different memory objects are accessed. If the two LOCs are different, the disambiguator determines that the memory references are independent, as indicated in a return block 204.

If the same object is accessed, as indicated by a no answer to decision block 202, the disambiguator then attempts to determine if overlapping portions of the object are accessed. Accordingly, the logic proceeds to a decision block 206 comprising a switch statement that redirects the process flow based on whether the memory object is a scalar, a record (i.e., data structure), or an array, as depicted by switch case blocks 208, 210, and 212, respectively. From the symbol table information, the disambiguator can determine the type of high-level object being accessed.

If the memory object is a scalar, data indicating that the memory references are dependent is returned in a block 214. If the memory object is a record, type information for the memory object is retrieved, a check is made to see if an overlap within the record exists, and the results of the type information and overlap check results are returned in a block 216. Structure type information from the symbol table is used to determine if overlapping fields of a structure are accessed. This information is generated by the front-end analysis provided in block 104 above, and is attached to the memory references in the IL. This information is stored in the disam token when the memory references are translated to the code generator's IL. The type information contains the type and offset information for the field within the structure.

If the memory object is an array, the array data dependence information is used to determine if the same array element is accessed. For array references, the disam token contains a key (data dependence key 22) that is used to access a table of array data dependence information. For two references to the same array object, a table lookup is done using the two keys. The result of the lookup is an indication of whether or not there is a dependence between the two array references and the characteristics of that dependence. The result of this determination is returned in a block 218.

If at least one of the memory references is indirect (as indicated by a no answer to decision block 200), the logic proceeds to a decision block 220, in which a determination is made to whether both references are indirect. If only one of the two references is indirect, the logic proceeds to blocks 222 and 224, in which properties for the direct reference, and properties for the pointer for the indirect reference are obtained from the symbol table. In the latter case, the LOC for the pointer is used to look up the symbol table information for that pointer. With reference to FIG. 8B, a determination is then made in a decision block 226 as to whether the pointer could possibly point to a directly accessed variable. As discussed above, an indirect reference off an unmodified parameter or a copy of that parameter could not possibly access a stack allocated local variable from the function in which the two references appear. If the pointer could not possibly point to the directly accessed variable, then the memory references are determined to be independent, as provided by a return block 228.

Returning to decision block 220, if both memory references are indirect (i.e., they both are pointers), the logic proceeds to a block 230 in which properties for both of the pointers are obtained from the symbol table. In a decision block 232 a determination is then made to whether the properties indicate that the two pointers could possibly access overlapping memory locations. If this determination is false, the disambiguator returns a result in a return block 234 indicating the memory references are independent.

If the determination for either of decision blocks 226 or 232 is yes, the logic proceeds to a block 235 in which a data dependence table lookup is done if the two memory references each have a valid data dependence key. The data dependence table lookup returns either independent, dependent, or don't know. As indicated by a decision block 236, if the result is known, the data dependence table lookup result is returned in a return block 238.

If the table lookup returns don't know, base and offset information is obtained in a block 240, and a determination is made in a decision block 242 to whether or not both memory references share the same base address. If they do, their offsets and sizes are compared to see if an overlap exists, and the results are returned in a block 244. If they do not share the same base address, the logic proceeds to a decision block 246 in which a determination is made to whether the points-to analysis has already been run. If it has, the points-to LOC sets for both memory references are obtained in a block 248, and the LOC sets are compared in a block 250. In a decision block 252, a determination is made to whether an intersection exists between the LOC sets. If no intersection exists, the memory references are independent, as indicated by a return block 254.

If either the point-to analysis has not been performed, or an intersection is found in decision block 252, the logic proceeds to obtain type and parameter information for both memory references, as provided by a block 256. Language type aliasability rules and other language rules are then applied, with the results being returned in a block 258. As described above, aliasability rules are used to determine whether certain object types can overlap with one another. If they can, the memory references are dependent. If they cannot, the memory references are independent. In the Fortran language, distinct by-reference parameters are always independent.

Exemplary Computer System for implementing the Invention

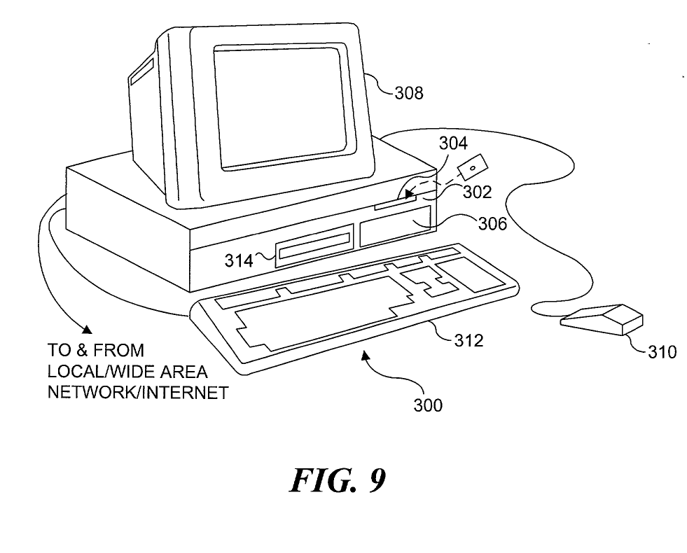

With reference to FIG. 9, a generally conventional computer 300 is illustrated, which is suitable for use in connection with practicing the present invention, and may be used for running a client application comprising one or more software modules that implement the various functions of the invention discussed above. Examples of computers that may be suitable for clients as discussed above include PC-class systems operating the Windows NT or Windows 2000 operating systems, Sun workstations operating the UNIX-based Solaris operating system, and various computer architectures that implement LINUX operating systems. Alternatively, other similar types of computers may be used, including computers with multiple processors. The computer may also be a server, such as a Hewlett Packard Netserver, an IBM Netfinity server, various servers made by Dell and Compaq, as well as UNIX-based servers and LINUX-based servers.

Computer 300 includes a processor chassis 302 in which are mounted a floppy disk drive 304, a hard drive 306, a motherboard populated with appropriate integrated circuits (not shown) including memory and one or more processors, and a power supply (also not shown), as are generally well known to those of ordinary skill in the art. It will be understood that hard drive 306 may comprise a single unit, or multiple hard drives, and may optionally reside outside of computer 300. A monitor 308 is included for displaying graphics and text generated by software programs and program modules that are run by the computer. A mouse 310 (or other pointing device) may be connected to a serial port (or to a bus port or USB port) on the rear of processor chassis 302, and signals from mouse 310 are conveyed to the motherboard to control a cursor on the display and to select text, menu options, and graphic components displayed on monitor 308 by software programs and modules executing on the computer. In addition, a keyboard 312 is coupled to the motherboard for user entry of text and commands that affect the running of software programs executing on the computer. Computer 300 may also include a network interface card (not shown) for connecting the computer to a computer network, such as a local area network, wide area network, or the Internet

Computer 300 may also optionally include a compact disk-read only memory (CD-ROM) drive 314 into which a CD-ROM disk may be inserted so that executable files and data on the disk can be read for transfer into the memory and/or into storage on hard drive 306 of computer 300. Other mass memory storage devices such as an optical recorded medium or DVD drive may be included. The machine instructions comprising the software program that causes the CPU to implement the functions of the present invention that have been discussed above will likely be distributed on floppy disks or CD-ROMs (or other memory media) and stored in the hard drive until loaded into random access memory (RAM) for execution by the CPU. Optionally, the machine instructions may be loaded via a computer network.

Although the present invention has been described in connection with a preferred form of practicing it and modifications thereto, those of ordinary skill in the art will understand that many other modifications can be made to the invention within the scope of the claims that follow. Accordingly, it is not intended that the scope of the invention in any way be limited by the above description, but instead be determined entirely by reference to the claims that follow.

What is claimed is:

1. A method for performing memory disambiguation in a compiler, comprising:
determining memory objects corresponding to memory references in one or more source files being compiled;
creating a memory disambiguation token for each memory reference, each memory disambiguation token identifying information particular to the memory reference it is associated with so as to preserve high-level and intermediate-level semantic information
creating a symbolic memory reference representation associated with each memory disambiguation token, including information on whether the memory reference is indirect or direct and access to symbol table information for a pointer to the memory object for indirect references or the memory object for direct references; and
determining if potentially dependent memory references are dependent or independent based on information contained in the disambiguation tokens for those memory references and their associated symbolic memory reference representations.

2. The method of claim 1, further comprising determining if memory references are redundant based on information contained in the disambiguation tokens for those memory references and their associated symbolic memory reference representations.

3. The method of claim 1, further comprising determining a relative difference in starting addresses for two memory references that are determined to be independent or dependent.

4. The method of claim 1, wherein the disambiguation token comprises a data structure including a plurality of links to data objects in which disambiguation information are stored

5. The method of claim 4, wherein the data structure is embedded in memory reference operators of an intermediate language produced during the compilation of said one or more source files.

6. The method of claim 1, wherein the disambiguation token associated with the memory object includes a key that is used to access a table of data dependence information.

7. The method of claim 1, wherein the disambiguation token contains a link to address base and offset information for the memory reference that is used for low-level disambiguation.

8. The method of claim 1, further comprising:
substituting a direct memory reference for an indirect memory reference; and
updating the disambiguation token corresponding to the memory reference to indicate the memory reference is now a direct memory reference.

9. The method of claim 1, further comprising using information identified by disambiguation tokens to determine sets of local memory objects that are not referenced after they are modified.

10. The method of claim 1, further comprising determining if two memory references access overlapping memory locations based on information contained in the disambiguation tokens for those memory references and their associated symbolic memory reference representations.

11. The method of claim 10, further comprising determining particularities of an overlap between two overlapping memory references.

12. The method of claim 1, further comprising:
determining the functions executed corresponding to function calls in the one or more source files being compiled;
creating a disambiguation token for each function call, each disambiguation token identifying information particular to the function call it is associated with so as to preserve high-level and intermediate level semantic information;
creating a symbolic function call representation associated with each disambiguation token, including information on whether the function call is indirect or direct and access to symbol table information for the pointer or function respectively; and
determining if potentially dependent calls and memory references are dependent or independent for the function calls based on information contained in the disambiguation tokens for the calls and memory references, their associated symbolic representation, an analysis of each function to determine the set of memory locations modified or referenced by the function.

13. The method of claim 1, wherein the disambiguation token contains a link to type information associated with the memory reference.

14. The method of claim 1, wherein the disambiguation token for an indirect memory reference contains a link to a set of memory objects accessible via the pointer as determined by points-to analysis.

15. The method of claim 1, further comprising using the disambiguation token and the symbolic memory reference representation as an interface or means of communication between various software components of a disambiguator that performs memory disambiguation functions and clients of the disambiguator.

16. A system comprising:
a memory in which a plurality of machine instructions comprising a compiler and programming code corresponding to one or more source files are stored; and
a processor coupled to the memory, executing the machine instructions to perform the functions of:
determining memory objects corresponding to memory references in said one or more source files;
creating a memory disambiguation token for each memory reference, each memory disambiguation token identifying information particular to the memory reference it is associated with so as to preserve high-level and intermediate-level semantic information
creating a symbolic memory reference representation associated with each memory disambiguation token, including information on whether the memory reference is indirect or direct and access to symbol table information for a pointer to the memory object for indirect references or the memory object for direct references; and
determining if potentially dependent memory references are dependent or independent based on information contained in the disambiguation tokens for those memory references and their associated symbolic memory reference representations.

17. The system of claim 16, wherein execution of the machine instructions by the processor further performs the function of determining if memory references are redundant based on information contained in the disambiguation tokens for those memory references and their associated symbolic memory reference representations.

18. The system of claim 16, wherein execution of the machine instructions by the processor further performs the function of determining relative positions of starting addresses for memory references that are independent or dependent.

19. The system of claim 16, wherein execution of the machine instructions by the processor further performs the functions of:
substituting a direct memory reference for an indirect memory reference; and
updating the disambiguation token corresponding to the memory reference to indicate the memory reference is now a direct memory reference.

20. The system of claim 16, wherein execution of the machine instructions by the processor further performs the function of using information identified by disambiguation tokens to determine sets of local memory objects that are not referenced after they are modified.

21. The system of claim 16, wherein execution of the machine instructions by the processor further performs the function of determining if two memory references access overlapping memory locations based on information contained in the disambiguation tokens for those memory references and their associated symbolic memory reference representations.

22. The system of claim 16, wherein execution of the machine instructions by the processor further performs the functions of:
determining the functions executed corresponding to function calls in the one or more source files being compiled;
creating a disambiguation token for each function call, each disambiguation token identifying information particular to the function call it is associated with so as to preserve high-level and intermediate level semantic information;
creating a symbolic function call representation associated with each disambiguation token, including information on whether the function call is indirect or direct and access to symbol table information for the pointer or function respectively; and
determining if potentially dependent calls and memory references are dependent or independent for the function calls based on information contained in the disambiguation tokens for the calls and memory references, their associated symbolic representation, an analysis of each function to determine the set of memory locations modified or referenced by the function.

23. An article of manufacture on which a plurality of machine instructions comprising a compiler are stored that upon execution of the machine instructions by a processor causes the functions to be performed, including:
determining memory objects corresponding to memory references in said one or more source files;
creating a memory disambiguation token for each memory reference, each memory disambiguation token identifying information particular to the memory reference it is associated with so as to preserve high-level and intermediate-level semantic information
creating a symbolic memory reference representation associated with each memory disambiguation token, including information on whether the memory reference is indirect or direct and access to symbol table information for a pointer to the memory object for indirect references or the memory object for direct references; and
determining if potentially dependent memory references are dependent or independent based on information contained in the disambiguation tokens for those memory references and their associated symbolic memory reference representations.

24. The article of manufacture of claim 23, wherein execution of the machine instructions further performs the function of determining if memory references are redundant based on information contained in the disambiguation tokens for those memory references and their associated symbolic memory reference representations.

25. The article of manufacture of claim 23, wherein execution of the machine instructions further performs the function of determining relative positions of starting addresses for memory references that are independent or dependent.

26. The article of manufacture of claim 23, wherein execution of the machine instructions further performs the functions of:
substituting a direct memory reference for an indirect memory reference; and
updating the disambiguation token corresponding to the memory reference to indicate the memory reference is now a direct memory reference.

27. The article of manufacture of claim 23, wherein execution of the machine instructions further performs the function of using information identified by disambiguation tokens to determine sets of local memory objects that are not referenced after they are modified.

28. The article of manufacture of claim 23, wherein execution of the machine instructions further performs the function of determining if two memory references access overlapping memory locations based on information contained in the disambiguation tokens for those memory references and their associated symbolic memory reference representations.

29. The article of manufacture of claim 23, wherein execution of the machine instructions further performs the functions of:
determining the functions executed corresponding to function calls in the one or more source files being compiled;
creating a disambiguation token for each function call, each disambiguation token identifying information particular to the function call it is associated with so as to preserve high-level and intermediate level semantic information;
creating a symbolic function call representation associated with each disambiguation token, including information on whether the function call is indirect or direct and access to symbol table information for the pointer or function respectively; and
determining if potentially dependent calls and memory references are dependent or independent for the function calls based on information contained in the disambiguation tokens for the calls and memory references, their associated symbolic representation, an analysis of each function to determine the set of memory locations modified or referenced by the function.

30. The article of manufacture of claim 23, wherein execution of the machine instructions further performs the functions of using the disambiguation token and the symbolic memory reference representation as an interface or means of communication between various software components of a disambiguator that performs memory disambiguation functions and clients of the disambiguator.
